(19) United States
(12) Patent Application Publication
(10) Pub. No.: US 2004/0103192 A1
(43) Pub. Date: May 27, 2004

(54) Method of generating charging data in a data network, and a data network

(75) Inventors: Jukka Pekka Yli-Korhonen, Oulu (FI); Ari Tapio Juntunen, Oulu (FI); Kimmo Olavi Keinanen, Oulu (FI)

Correspondence Address: COHEN, PONTANI, LIEBERMAN & PAVANE, 551 FIFTH AVENUE, SUITE 1210, NEW YORK, NY, 10176, US

(73) Assignee: TeliaSonera Finland Oyj

(21) Appl. No.: 10/679,213

(22) Filed: Oct. 3, 2003

Related U.S. Application Data
(63) Continuation of application No. PCT/FI02/00288, filed on Apr. 4, 2002.

(30) Foreign Application Priority Data
Apr. 5, 2001 (FI) 20010713

(51) Int. Cl. G06F 15/173

(52) U.S. Cl. 709/224

(57) ABSTRACT

A method of generating charging data in a data network, and a data network are provided. The method comprises: transmitting data generated by a content provider in a content server to a node of a data transmission connection used by a connection provider; transmitting the data of a service entity generated by the content provider from the node through the data transmission connection used by the connection provider to a subscriber terminal; identifying in the node individual transactions in the data to be transmitted to the subscriber terminal; transmitting the identification information of the identified transactions from the node to the charging information system of the connection provider; identifying in the charging information system the individual transactions in a chargeable service entity; generating in the charging information system one content ticket for each identified service entity, and using the content ticket in billing for the service entity.

This application is a Continuation of International Application PCT/FI02/00288 filed on Apr. 4, 2002, which designated the U.S. and was published under PCT Article 21(2) in English. METHOD OF GENERATING CHARGING DATA IN A DATA NETWORK, AND A DATA NETWORK

### FIELD OF THE INVENTION

The invention relates to a method of generating charging data in a data network, and to a data network.

### BACKGROUND OF THE INVENTION

A data network refers herein to both the conventional TCP/IP protocol-based Internet and a mobile system employing the wireless application protocol (WAP), as well as to third-generation mobile systems, for instance the UMTS (Universal Mobile Telecommunications System), including their Internet connections. The services of the data network can be used by utilising both the conventional Internet technology and the WAP technology. The Internet is a worldwide, TCP/IP-based open data network. When taken expansively, the Internet includes the intranet, which is an internal data network of an organisation, and the extranet, which is an inter-organisational data network intended for a restricted group of users. They, too, employ the TCP/IP protocol and the Internet, in its narrow sense, is generally utilised in their implementation. WAP is a protocol specification, by means of which subscriber terminals in a mobile system can use services provided on the Internet, intranet or extranet, which in this context are called WAP services. Third-generation mobile systems refer to advanced digital, broadband network-based systems intended for worldwide use. One such system is the European UMTS based on WCDMA (Wideband Code Division Multiple Access) technology.

Internet services are typically used through a telecommunications connection provided by an Internet connection provider and a server used for the connection. WAP services are typically used through a WAP gateway maintained by a WAP connection provider. The term connection provider is used herein for both an Internet connection provider and a WAP connection provider. A connection provider refers herein to an operator providing a portal, an operator providing a connection, and an operator providing a charging service.

Internet services can be used based on either the conventional request-response (pull) technology or push technology. In the request-response technology, a service request from a subscriber terminal is identified at a node of a network system and forwarded to a content server providing the requested service, after which response data generated in the content server on the basis of the service request is forwarded to the subscriber terminal. In the push technology, a server transmits data to a subscriber terminal on the basis of a request made once by the user without a transmission request related to an individual transmission. WAP services are today used mainly by employing the request-response technology, but services based on the push technology are also being introduced for a wider use. If required, further information can be found on the home page of WAP Forum working on the WAP specification at http://www.wapforum.org.

Billing for the use of WAP services is typically based on the connection time used for data transmission. If the bi-directional data transmission connection between the subscriber terminal and network part of a mobile system is a circuit-switched connection, for instance a data call connection, connection time-based charging is a natural charging method. The problem with this is that it is difficult to divide the billed amount of money between the different services or service entities used during a specific connection time.

Billing for the use of Internet services is typically based on an agreement signed between the user and the content provider, on the basis of which a fixed monthly charge, for instance, is defined for the use of the service. In addition, the connection provider charges the user for the used telecommunications connection according to a separate agreement. A problem with this system is for instance that the user needs to sign agreements with several different parties to be able to use different service entities and the Internet connection.

Billing can also be based on the number of data packets transmitted through a packet-switched connection. If the telecommunications connection between the subscriber terminal and network part of the mobile system is a packet-switched connection, for instance a connection using a short message service (SMS), packet-switched data service, i.e. GPRS (General Packet Radio Service), or UMTS, charging can be done on the basis of the number of the transmitted packets. A drawback of this method is that it is difficult to combine service events belonging to one service entity but provided by different content providers and, on the other hand, to distinguish them from the service events provided by different content providers. Another problem is that the use of one and the same service may require a different number of transactions in different subscriber terminals. In such a case, the users of different subscriber terminals pay a different price for the same service entity when the charging is done on the basis of the number of data packets.

For WAP-service billing, event-based charging methods, based on identifying transactions, i.e. individual service events of a service entity, have also been developed. In the request-response technology, a transaction is one request-response pair. A method based on analysing an URL address has earlier been used as such an event-based system, in which the transactions belonging to a given service entity are identified and one of the transactions is selected for charging. A problem with this method is that the transactions related to one service entity cannot be combined, and one of the events must be selected as the charged event. In such a case, a problem arises from processing error situations and from the fact that the number of transactions varies in different subscriber terminals. In an error situation, in which the transaction marked for charging fails, the user is not charged at all for the use of the service entity. Then again, in a situation, in which the user obtains the transaction marked as chargeable but not all transactions belonging to the service entity, the user is charged for an incomplete service entity. Charging in a situation, in which the user interrupts the service, also poses a problem. A further problem of the method is that URL address-based charging requires a great deal of testing and configuration from the charging system, because the URL address of each individual service must be found and configured for charging.

### BRIEF DESCRIPTION OF THE INVENTION

It is an object of the invention to provide an improved method of generating charging data in a data network and an improved data network implementing the method. As one aspect of the invention, the method for generating charging data as claimed in claim 1 is disclosed. As another aspect of the invention, the data network as claimed in claim 30 is disclosed. Other preferred embodiments of the invention are disclosed in the dependent claims.

The invention is based on creating a general-purpose method of identifying individual transactions in a service entity and generating from them one content ticket for each service entity so as to be able to identify, monitor and charge for service entities based on the content ticket.

The invention describes a general method of generating content-based charging data of a service entity, so the need for situation-oriented solutions and configurations is significantly reduced. The solution is reusable, i.e. it can be used in connection with different services and service entities. It can be used in both the conventional TCP/IP-based Internet and a data transmission system employing the wireless application protocol (WAP), as well as in third-generation mobile systems, for instance UMTS (Universal Mobile Telecommunications System), including their Internet connections.

The method and arrangement of the invention are also system or manufacturer-independent, i.e. the node of the used data transmission connection—in the case of a system using the wireless application protocol, the WAP gateway—need not be the hardware of the same system or manufacturer as that in which the content ticket is generated.

A content provider produces service entities whose delivery to the user of a subscriber terminal typically requires several separate transactions. By means of the invention, it is possible to assemble the separate transactions in a content entity together and to charge for the entire service entity instead of individual transactions. Being able to charge for service entities, the connection provider is also better able to assign to each different content provider its share of the charged amount of money, which often presents problems. On account of the invention, the connection provider need not decide which transaction to select for charging, contrary to the transaction-based charging that was applied before.

The content ticket of the invention also enables more versatile charging rules. If the user of a service entity interrupts its use before receiving all parts of the service entity, it is possible to charge for a certain proportion of the price of the service entity on the basis of the content ticket. If, as in the earlier transaction-based charging method, only one transaction was selected from the service entity, on the basis of which the user was charged for the entire service entity, it would be possible that the user was also charged for parts of the service that he did not receive. Or on the other hand, it would be possible that the user was not charged at all for the service, if the user did not receive the transaction that was selected for charging. On the basis of the content ticket, it is also possible not to charge the user for the entire service, if the use of the service entity was interrupted due to reasons beyond the user's control. By means of the content ticket, the user can also be charged based on how far he has proceeded in the service entity. For instance, if the service entity the user is using is a game, in which he proceeds to the second level, where the game ends, the user can be charged less than if he had not proceeded to the second level.

Information on the user of the service, such as MSISDN (Mobile Subscriber International ISDN Number), or the IP address of the subscriber terminal, is always attached to the content ticket of the invention. Other information is also attached to the content ticket, such as the service URL, the name of the service, start and end time, information on the success of the content ticket generation, or information on the success of the individual transactions of the service entity. These enable versatile monitoring and event management.

In the system of the invention, the connection provider can configure the generation rules of the content ticket. This makes it possible for the connection provider to create by means of the method a charging and monitoring system that exactly corresponds to its needs and the current situation. The configuration rules can be created together with the content provider, because the content provider can best define which transactions the service entity consists of. Configuration also includes the definition of the transactions in the service entity that are chargeable, i.e. menus, for instance, can be defined non-chargeable.

The connection provider can define the basis for identifying the transactions, from which the content ticket is generated. This can be done for instance on the basis of the URL or IP address of the content provider or a specific content identifier (content_id) attached to the transaction and defined according to the invention. Likewise, the grounds for identifying the transactions belonging to a content entity of a content provider and to be included into the same content ticket are defined. According to the invention, this can be done for instance by means of a specific content identifier (content_id) attached by the content provider to the transaction. These identifiers can be indicated in key fields added to the header information, for instance http header information, of individual transactions.

The connection provider also adds a specific service platform identifier (serviceplatform_id) to the content ticket for identifying the service platform and content provider from which the transaction originates. This is used to distinguish the contents arriving from different service platforms and content providers, because several content providers may use the same content identifier space. According to the invention, this can be done in such a manner, for instance, that the content provider inserts the service platform identifier (serviceplatform_id) to key fields added to the header information, for instance http header information, of individual transactions.

The use of the content identifier and the service platform identifier is clarified by the example in the following table, in which the service entity consists of providing a three-frame cartoon to a user of the service. In one subscriber terminal, the transmission of the cartoon to the user requires thirteen transactions. In the example, each frame comprises three different frame elements and the header information of the frame.

| | | Service platform identi- |
|---|---|---|
| Transaction having URL | Content identifier | fier |
| Common http header | 12345 | 99999 |
| info for entire cartoon | | |
| Header info for first | 12345 | 99999 |
| frame | | |
| First frame element of | 12345 | 99999 |
| first frame | | |
| Second frame element | 12345 | 99999 |
| of first frame | | |
| Third frame element of | 12345 | 99999 |
| first frame | | |
| Header info for second | 12345 | 99999 |
| frame | | |
| First frame element of | 12345 | 99999 |
| second frame | | |
| Second frame element | 12345 | 99999 |
| of second frame | | |
| Third frame element of | 12345 | 99999 |
| second frame | | |
| Header info for third | 12345 | 99999 |
| frame | | |
| First frame element of | 12345 | 99999 |
| third frame | | |
| Second frame element | 12345 | 99999 |
| of third frame | | |
| Third frame element of | 12345 | 99999 |
| third frame | | |

The content identifier and a possible service platform identifier can also be transmitted to the connection provider separate from the actual transaction data by using a separate signalling channel. In such a case, information on which transaction and subscriber the transmitted identifiers belong to must be added to the identifiers. This can be done for instance by transmitting together with the identifier information a user identifier, for instance MSISDN or IP address, and a transaction identifier, for instance by means of a separate transaction-specific identifier attached to the transactions and identifier information, or by transmitting together with the identifier information time information, by means of which charging information can be combined with status information obtained from the node of the data transmission system, for instance the WAP gateway or http proxy server.

### BRIEF DESCRIPTION OF THE FIGURES

The invention will now be described in greater detail by means of preferred embodiments and with reference to the attached drawings, in which

FIG. 1 is a simplified block diagram showing a mobile system employing the wireless application protocol as an example of a data network system,

FIG. 2 shows the generation of a content ticket on the basis of transactions,

FIG. 3 is a flow chart showing a method of generating charging data in a data network.

### DESCRIPTION OF THE EMBODIMENTS

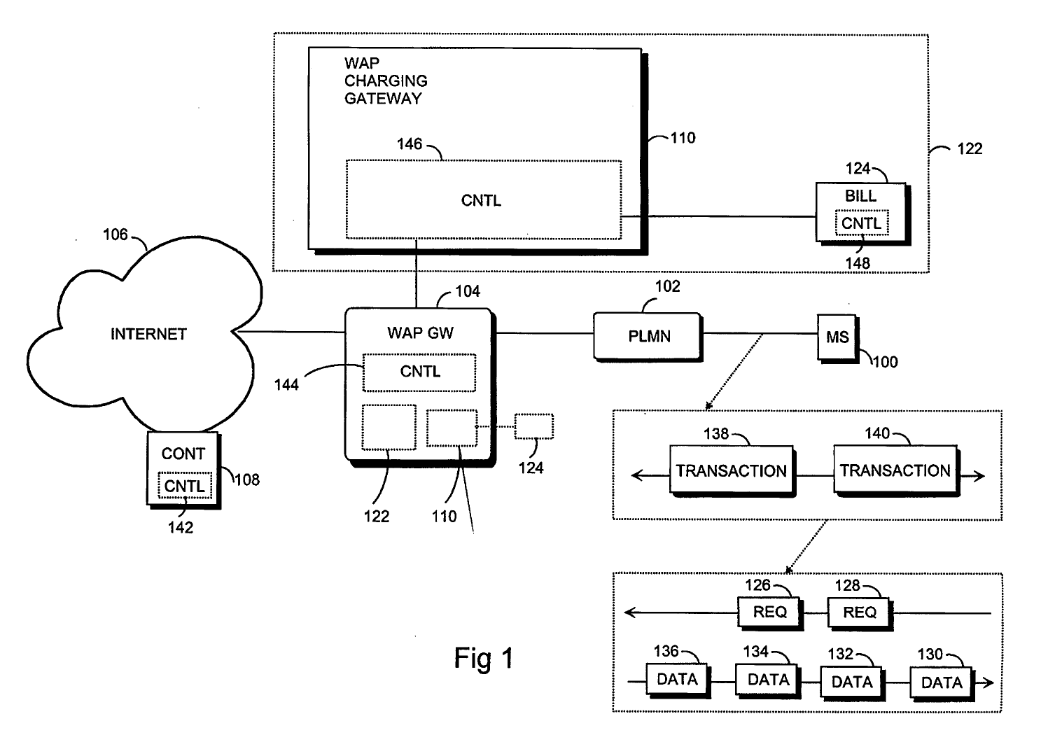

FIG. 1 shows the application of the method to a mobile system employing the wireless application protocol (WAP) that uses the request-response technology. The application of the invention is not, however, restricted to the case of the example, but the invention can also be applied to other data networks, such as the conventional Internet or third-generation mobile systems, for instance UMTS.

FIG. 1 is a simplified general view of a WAP system of the invention connected to the network part of a mobile system. The mobile system can be for instance a GSM system, GPRS system, UMTS system or some other mobile system employing the wireless application protocol (WAP).

As shown in FIG. 1, it is possible to establish a data transmission connection from a subscriber terminal 100 through a public land mobile network (PLMN) 102 to a node 104 of a data network, in this case a WAP gateway 104. A connection is then established from the WAP gateway 104 through the Internet 106 to a content server 108 of a content provider providing the desired service entity. The connection is established on the basis of the Internet address of the service, i.e. the WAP gateway 104 has means 144 for transmitting a service request 126, 128 sent by the subscriber terminal 100 to the content server 108. Correspondingly, the WAP gateway 104 has means 144 for transmitting response data 130, 132, 134, 136 generated by the content provider in the content server 108 on the basis of the service request 126, 128 to the subscriber terminal 100. The content server comprises means 142 to receive the service request and to transmit the response data to the WAP gateway 104. The WAP gateway 104 and the content server 108 are preferably implemented by hardware equipped with a microprocessor, for instance a computer with its peripherals, and with the required system and application programs. The means 144, 142 are thus preferably computer modules that implement the required functionality. The means 142, 144 can be implemented for instance in the control part by using processors and their software, whereby the functionality of the means is implemented as parts of software, for instance program modules. During the design and implementation of the system, the distribution of the functions between the software and hardware is determined for instance on the basis of the manufacturing costs and the required data processing capacity and rate. Some of the functions can be implemented by hardware.

Even though FIG. 1 shows the service requests and response data as packets, such as messages of a short message service, they can as well be transmitted over a circuit-switched connection, such as a data call. The essential matter is that the traffic can be analysed and the transactions related to a specific service and service entity can be identified from it. In the example of FIG. 1, four response data packets 130, 132, 134, 136 correspond to two service requests 126, 128 of the user, but other kinds of combinations are also possible. Thus, there may be one or more service requests and responses. This makes it difficult to identify what traffic belongs to which service and service entity.

Even though the service event in FIG. 1 is shown using the request-response (pull) technology, it can also use the push technology, in which a server transmits data to a subscriber terminal on the basis of a request made once by the user without a transmission request related to an individual transmission.

The method can be applied using both a connection-oriented and a connectionless data transmission connection.

A billing system 122 is connected to the WAP gateway. The billing system comprises a billing unit 124 that further comprises billing means 148. A charging information system (WAP charging gateway) 110 is connected to the billing system 122, which depending on the implementation can be a separate unit or a part of the billing system 122. It can also be implemented as a part of the WAP gateway 104. The billing system 122 can depending on the implementation be a separate unit or a part of the WAP gateway 104, or it can belong partly to the WAP gateway while a part of the billing system remains outside the WAP gateway.

The charging information system 110 comprises the following parts: identification means 146 to identify the chargeable transactions 138, 140 of the chargeable service entity, and means 146 for generating a content ticket 224, 226 of the service entity. The identification means 146 and means 146 for generating the content ticket 224, 226 as well as the billing unit 124 with its billing means 148 are implemented, like the WAP gateway, as a suitable combination of hardware and software.

The connection provider can define when the generation of the content ticket 224, 226 is started, how the individual transactions, from which the ticket is generated, are identified, how the content ticket is generated and what is included in it. A content ticket is not generated from all transactions or services, but information on some of the transactions, for instance individual transactions, can be forwarded directly to the billing system. The connection provider can configure its charging information system 110 to decide whether a content ticket is generated, based on the identification of the content provider 108 or the identification of the transaction 138, 140, for instance. The decision to start generating a content ticket 224, 226 can be made based on identifying a specific URL or IP address of a content provider with the means 146 and on the basis of the address, the transactions are identified to be ones from which the content ticket can be generated.

When the connection provider decides to start generating the content ticket, its charging information system identifies the transactions related to the service entity, from which the content ticket is generated. This is done by means of the content identifier (content_id) attached to the transaction, i.e. the same content identifier is attached to the transactions that belong to the same service entity. The content identifier is a subscriber-specific and session-specific identifier that the content provider 108 attaches with the means 142 to each service entity.

The connection provider can also configure its charging information system 110 to decide whether to start generating the content ticket based on identifying the content identifier (content_id) related to a transaction with the means 146. If the content identifier is not found, the content ticket is not generated.

A service platform identifier (serviceplatform_id) related to the transaction is also attached to the content ticket by using the means 146. With this identifier, it is possible to identify both the content provider and the service platform, from which the content is provided. One content provider may have several service platforms, from which it provides identical content, it can for instance provide the same content entity both as a conventional Internet service and as a WAP service, or it can provide the content from several different content servers. The service platform identifier makes it possible to distinguish the different content providers from each other, since several different content providers can use the same content identifier space. On the basis of the identifier, it is for instance possible to assign to the content provider its share of the amount of money charged from the user for the service entity.

With the means 142, the content provider 108 can attach the service platform identifier (serviceplatform_id) to each transaction of its service response. If the content provider does not attach the service platform identifier to the transactions, the connection provider can generate it on the basis of the URL or IP address of the content provider and attach it to the content ticket by using the means 146. Even though the content provider did not attach the identifier to its service, or only attached it to its services arriving from certain service platforms, it is in this manner possible to have an identifier describing the content provider in the content ticket, and on the basis of the identifier, the ticket can be used to assign a charging event and the processing of a bill to the service provided by the correct content provider and service platform.

The content identifier (content_id) and the service platform identifier (serviceplatform_id) can be transmitted by means of the means 142 to the connection provider in key fields attached to the header information of the service response, typically in the key fields of http headers. The identifiers can, however, also be transmitted separate from the service response data.

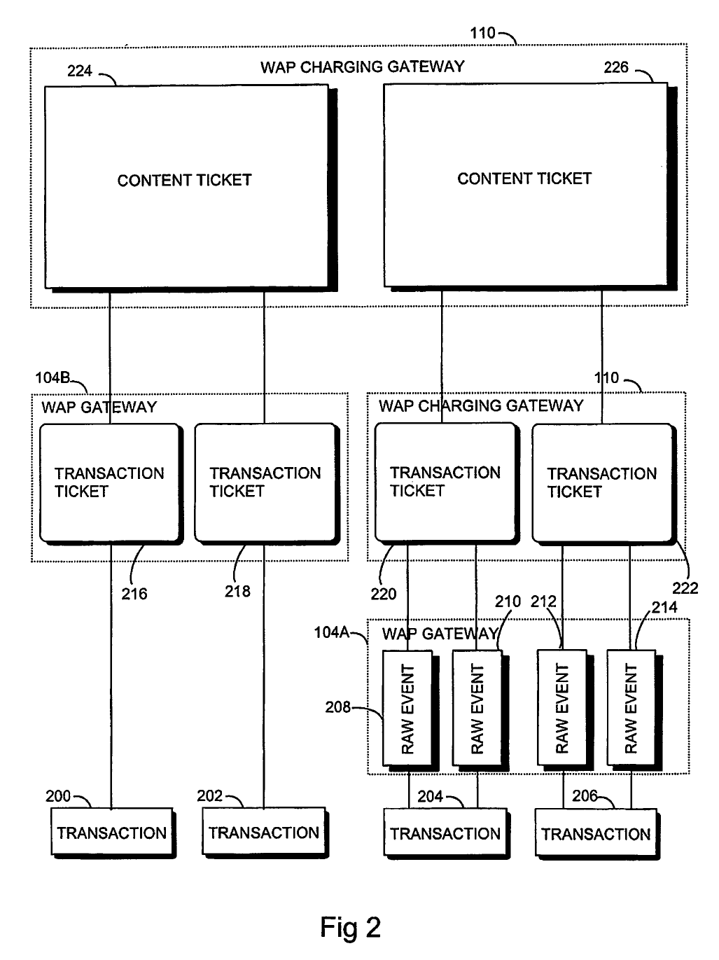

The connection provider generates the content ticket on the basis of the transaction identification information obtained from the WAP gateway 104. The WAP gateway 104 can generate the required identification information as shown in FIG. 2 either in such a manner that the WAP gateway 104B generates with the means 144 one transaction ticket 216, 218 of each transaction 200, 202 or the WAP gateway 104A generates with the means 144 several raw events 208, 210, 212, 214 of each transaction 204, 206. In the charging information system 110, these raw events 208, 210, 212, 214 can then be generated into a transaction ticket 220, 222 with the means 146. The content ticket 224, 226 is generated in the charging information system 110 by identifying and combining the transaction tickets 216 and 218 or 220 and 222 belonging to one service entity by means of the content identifier (content_id) and the service platform identifier (serviceplatform_id) with the means 146.

The connection provider can configure the generation of the content ticket as needed. In addition to the required user identifier, typically the MSISDN number, content identifier (content_id) and the service platform identifier (serviceplatform_id), it is also possible to attach to it for instance information on the success of the ticket generation or information on the success of individual transactions, or for instance information on the name of the service entity.

The finished content ticket of the service entity is used in the billing unit 124 to charge for the service entity by means of the billing means 148. The content ticket can also be used in monitoring and collecting statistics, for instance when needing information on the success of the service or when examining the functionality of different service entities in different environments and terminals.

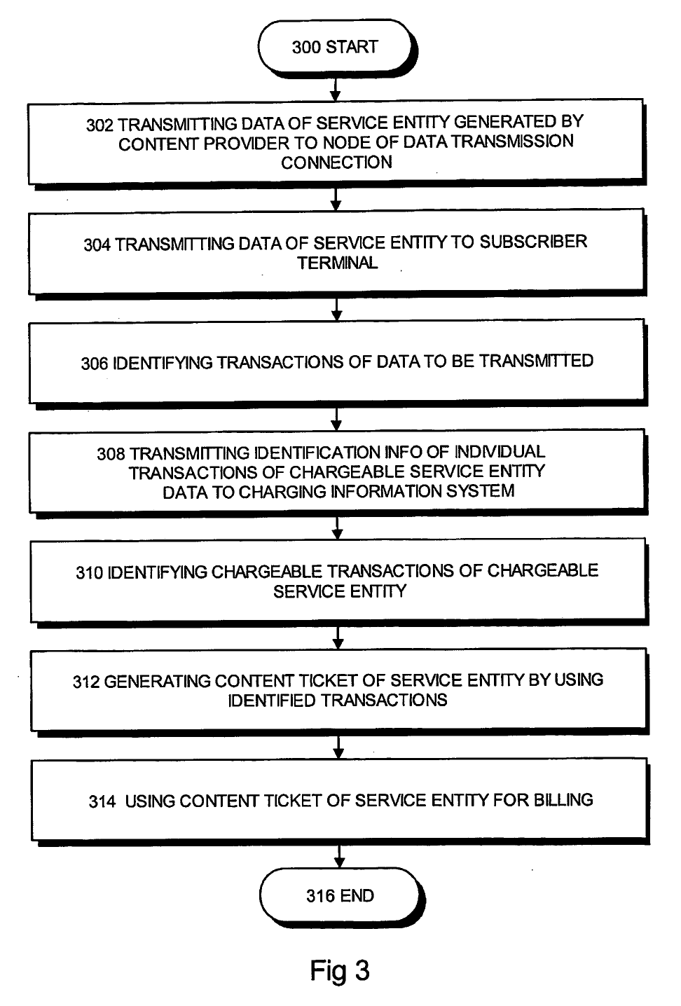

Finally, the flow chart in FIG. 3 shows a method of generating charging information in a data network.

The method starts from block 300. In block 302, the data of the service entity generated by the content provider is transmitted to a node of the data transmission connection. In block 304, the data of the service entity is transmitted to the subscriber terminal.

In block 306, the transactions of the transmitted data are identified. This takes place in the node 104 of the data network, in which the transaction tickets 216, 218 or raw events 208, 210, 212, 214 are also generated. In the next block 308, the identifier information of the identified transactions, for instance the transaction tickets 216, 218 or raw events 208, 210, 212, 214, is transmitted to the charging information system 110.

In block 310, the chargeable transactions of the chargeable service entity are identified. The identification is done by identifying the URL or IP address or content identifier as described above and on the basis of the identification, a decision is made whether to start generating the content ticket or not. When the transaction is identified as one from which a content ticket is generated, the transactions belonging to one service entity are always identified on the basis of the content identifier and service platform identifier of the transaction. Next, in block 312, the content ticket 224, 226 of the service entity is generated using the identified transactions. This is preferably done on the basis of the content identifier and service platform identifier and by attaching to the ticket all other necessary information, such as the user identifier, for instance MSISDN, and by adding, as described above, other information, such as the name of the service or success information as necessary. Finally, in block 314, the content ticket of the service entity is used in billing.

Even though the invention has been explained in the above with reference to examples in accordance with the accompanying drawings, it is apparent that the invention is not restricted to them but can be modified in many ways within the scope of the inventive idea disclosed in the attached claims.

1. A method of generating charging data in a data network, comprising:
transmitting data generated by a content provider in a content server to a node of a data transmission connection used by a connection provider;
transmitting the data of a service entity generated by the content provider from the node through the data transmission connection used by the connection provider to a subscriber terminal;
identifying in the node individual transactions in the data to be transmitted to the subscriber terminal;
transmitting the identification information of the identified transactions from the node to the charging information system of the connection provider;
identifying in the charging information system the individual transactions in the chargeable service entity;
generating in the charging information system one content ticket for each identified service entity, and using the content ticket in billing for the service entity.

2. A method as claimed in claim 1, wherein the data network is selected from a group comprising: the Internet, a mobile system employing the wireless application protocol (WAP).

3. A method of claim 1, further comprising generating transaction-specific tickets on the basis of the transactions by the connection provider.

4. A method of claim 1, wherein the charging information system is a WAP charging gateway.

5. A method of claim 1, further comprising generating, by the connection provider, the content ticket on the basis of the transaction tickets generated on the basis of the individual transactions.

6. A method of claim 1, further comprising:
defining a content identifier identifying the chargeable service entity, and
transmitting to the connection provider the content identifier associated with the transaction of the service entity to be transmitted to the subscriber terminal.

7. A method of claim 1, wherein a content identifier is used to identify the transactions of the chargeable service entity.

8. A method of claim 1, further comprising generating the content ticket of the chargeable service entity by using a content identifier.

9. A method of claim 1, further comprising generating, by the content provider, a content identifier associated with the individual transactions.

10. A method of claim 1, further comprising inserting a content identifier in the header information of the individual transactions of the service entity.

11. A method of claim 1, further comprising inserting a content identifier in the http header information of the individual transactions of the service entity.

12. A method of claim 1, further comprising transmitting a content identifier separate from the data of the individual transactions of the service entity.

13. A method of claim 1, further comprising defining a service platform identifier identifying the service platform of the content provider.

14. A method of claim 1, further comprising generating a service platform identifier by the content provider.

15. A method of claim 1, further comprising transmitting a service platform identifier to the connection provider, the service platform identifier associated with the transaction of the service entity to be transmitted to the subscriber terminal.

16. A method of claim 1, further comprising generating, by the connection provider, a service platform identifier associated with the individual transaction of the service entity to be transmitted to the subscriber terminal.

17. A method of claim 1, further comprising using a service platform identifier for identifying the transactions of the chargeable service entity.

18. A method of claim 1, further comprising using a service platform identifier for generating the content ticket of the chargeable service entity.

19. A method of claim 1, further comprising inserting a service platform identifier in the header information of the individual transactions of the service entity.

20. A method of claim 1, further comprising inserting a service platform identifier in the http header information of the individual transactions of the service entity.

21. A method of claim 1, further comprising transmitting a service platform identifier separate from the data of the individual transactions of the service entity.

22. A method of claim 1, wherein a numerical IP address of the service is used to identify the transactions of the chargeable service entity.

23. A method of claim 1, wherein a numerical IP address of the service is used in generating a service platform identifier.

24. A method of claim 1, wherein a URL address of the service is used to identify the transactions of the chargeable service entity.

25. A method of claim 1, wherein a URL address of the service is used in generating the service platform identifier.

26. A method of claim 1, further comprising attaching a user identifier to the content ticket.

27. A method of claim 1, wherein a user identifier attached to the content ticket is the international ISDN number of the mobile subscriber.

28. A method of claim 1, wherein a user identifier attached to the content ticket is an IP address identifying the subscriber terminal in the Internet network.

29. A data network comprising:
a content server of a content provider that has a connection through the Internet to a node of a data transmission connection used by a connection provider, from which there is a connection through a data transmission connection used by the connection provider to a subscriber terminal, in addition, there is a connection to a charging information system from the node, and the node comprises means for identifying individual transactions in data to be transmitted to the subscriber terminal;
means for identifying the individual transactions of a chargeable service entity in the charging information system;
means for generating in the charging information system one content ticket for each service entity, and
means for using the content ticket in billing for the service entity.

30. A data network of claim 29, wherein the data network is selected from a group comprising: the Internet, a mobile system employing the wireless application protocol (WAP).

31. A data network of claim 29, further comprising means used by the connection provider, the means for generating transaction-specific tickets on the basis of transactions.

32. A data network of claim 29, wherein the charging information system is a WAP charging gateway.

33. A data network of claim 29 further comprising means used by the connection provider, the means for generating a content ticket on the basis of the transaction tickets generated on the basis of the individual transactions.

34. A data network of claim 29, further comprising:
means for defining a content identifier identifying a chargeable service entity, and
means for transmitting to the connection provider the content identifier associated with the transaction of the service entity to be transmitted to the subscriber terminal.

35. A data network of claim 29, further comprising means for using the content identifier to identify the transaction of the chargeable service entity.

36. A data network of claim 29, further comprising means for generating a content ticket for the chargeable service entity by using the content identifier.

37. A data network of claim 29, further comprising means used by the content provider, the means for generating the content identifier associated with individual transactions.

38. A data network of claim 29, further comprising means for inserting the content identifier in the header information of the individual transactions of the service entity.

39. A data network of claim 29, further comprising means for inserting the content identifier in the http header information of the individual transactions of the service entity.

40. A data network of claim 29, further comprising means for transmitting the content identifier identifying the service entity separate from the data of the individual transactions of the service entity.

41. A data network of claim 29, further comprising means for defining a service platform identifier identifying the service platform of the content provider.

42. A data network of claim 29, further comprising means used by the content provider, the means for generating the service platform identifier.

43. A data network of claim 29, further comprising means for transmitting to the connection provider a service platform identifier associated with the transaction of the service entity to be transmitted to the subscriber terminal.

44. A data network of claim 29, further comprising means used by the connection provider, the means for generating a service platform identifier associated with the individual transaction of the service entity to be transmitted to the subscriber terminal.

45. A data network of claim 29, further comprising means for using a service platform identifier for identifying the transactions of the chargeable service entity.

46. A data network of claim 29, further comprising means for using a service platform identifier for generating the content ticket of the chargeable service entity.

47. A data network of claim 29, further comprising means for inserting a service platform identifier in the header information of the individual transactions of the service entity.

48. A data network of claim 29 further comprising means for inserting a service platform identifier in the http header information of the individual transactions of the service entity.

49. A data network of claim 29, further comprising means for transmitting a service platform identifier separate from the data of the individual transactions of the service entity.

50. A data network of claim 29, further comprising means for using a numerical IP address of the service to identify the transactions of the chargeable service entity.

51. A data network of claim 29, further comprising means for using a numerical IP address of the service in generating the service platform identifier.

52. A data network of claim 29, further comprising means for using a URL address of the service to identify the transactions of the chargeable service entity.

53. A data network of claim 29, further comprising means for using a URL address of the service in generating the service platform identifier.

54. A data network of claim 29, further comprising means for attaching a user identifier to the content ticket.

55. A data network of claim 29, wherein a user identifier attached to the content ticket is the international ISDN number of the mobile subscriber (MSISDN).

56. A data network of claim 29, wherein a user identifier attached to the content ticket is in IP address identifying the subscriber terminal in the Internet network.
